(19) United States
(12) Patent Application Publication
(10) Pub. No.: US 2020/0166474 A1
(43) Pub. Date: May 28, 2020

(54) SENSOR MEMBRANE, MEMBRANE CAP AND OPTOCHEMICAL SENSOR

(71) Applicant: Endress+Hauser Conducta GmbH+Co. KG, Gerlingen (DE)

(72) Inventors: Andreas Löbbert, Waldheim (DE); Michael Hanko, Dresden (DE)

(21) Appl. No.: 16/695,684

(22) Filed: Nov. 26, 2019

(30) Foreign Application Priority Data
Nov. 27, 2018 (DE) 10 2018 129 969.9

(51) Int. Cl. G01N 27/40; G01N 21/77

(52) U.S. Cl. CPC G01N 27/40; G01N 2021/7786; G01N 2021/775; G01N 21/77

(57) ABSTRACT

The present disclosure relates to a sensor membrane for an optochemical sensor for determining a measurand correlating with a concentration of an analyte in a measuring fluid, comprising: a functional layer comprising a first polymer matrix doped with a luminescent dye whose emissivity after excitation with electromagnetic radiation can be changed by the analyte; and a second polymer matrix in which the functional layer is at least partially encapsulated and which is permeable to the analyte at least in a subregion facing the measuring fluid and adjacent to the functional layer, wherein the sensor membrane comprises an optically detectable substance, different from the luminescent dye, for marking the sensor membrane. The present disclosure further relates to a membrane cap having such a sensor membrane and an optochemical sensor.

### CROSS-REFERENCE TO RELATED APPLICATION

The present application is related to and claims the priority benefit of German Patent Application No. 10 2018 129 969.9, filed on Nov. 27, 2018, the entire contents of which are incorporated herein by reference.

### TECHNICAL FIELD

The present disclosure relates to an optochemical sensor for determining a measurand correlating with a concentration of an analyte in a measuring fluid.

### BACKGROUND

Optochemical sensors for measuring the concentration or the partial pressure of specific substances, so-called analytes, in measuring media are based on the principle of the analyte-induced quenching of the luminescence (luminescence quenching) of a luminescent, e.g., fluorescent or phosphorescent, substance, hereinafter also referred to as luminescent dye. This substance can be, for example, an organic dye. Examples of luminescence are fluorescence and phosphorescence.

Optochemical sensors frequently comprise a membrane which contains the luminescent dye and which is frequently formed from one or more polymer materials. For measurement, the membrane is brought into contact with the measuring medium so that the analyte can penetrate into the membrane and interact with the luminescent dye. Such membranes can comprise a layer system, wherein individual layers of the layer system each have a specific chemical composition that differs from the other layers and accordingly have specific properties. For instance, layers may be provided which bring about selectivity of the sensor by selectively allowing diffusion of the analyte toward deeper layers of the layer stack. Other layers may contain the luminescent dye. Further layers may cause mechanical or chemical stabilization of the layer stack or be designed to absorb ambient light which would interfere with the measurement. Such layers, whose properties have an influence on the function of the sensor, are also referred to as functional layers of the membrane. For stabilization, membranes of optochemical sensors can comprise a substrate on which further layers of the membrane are applied and connected by physical or chemical methods.

In the course of their service life, such sensor membranes are exposed to aging, which can lead to a gradual deterioration of the sensor properties, for example, a sensor drift. For instance, substances present in the functional layers may degrade and/or be discharged or washed out of the membrane in contact with the measuring medium. This especially relates to the luminescent dye. A reduction in the concentration of the luminescent dye in the sensor membrane may lead to a reduction in the sensitivity of the optochemical sensor and possibly also to highly compromised measurement results. The aging of the sensor membranes, which is unavoidable even under moderate conditions of use, is intensified by extreme conditions of use, for example, by sterilization processes or contact with aggressive media, such as strong acids or alkaline solutions. Under such conditions, damage to the sensor membrane can occur within a short time, i.e. even after a few measurements, and such damage may be so serious that the sensor no longer appears suitable for further use. Such damage may, for example, consist in the detachment of individual layers of the sensor membrane.

DE 10 2014 112 972 A1 discloses an optochemical sensor which retains its operability even under rough environmental conditions, for example in the case of regular sterilization of the sensor membrane or regular cleaning processes with hot lye. This sensor comprises a sensor membrane which has a sensor element with at least one functional layer containing a luminescent dye. The sensor membrane further comprises a matrix in which the sensor element is fully embedded. The matrix consists of a material which is permeable to the analyte at least in a subregion facing the medium and adjacent to the sensor element. The embedding of the sensor element in a matrix ensures that the functional layers of the sensor element at least do not come into direct contact with aggressive media and additionally protects the functional layers from mechanical detachment. This reduces the risk of damage and delays aging of the sensor membrane due to the discharge of substances from the functional layers.

Despite these measures for protection against aging and damage, sensor membranes are often wear parts which have to be replaced regularly. For example, there are optochemical sensors which have a sensor body and a membrane cap that can be detachably connected to the sensor body. While the sensor body contains long-lived optical and electrical or electronic components of the sensor that serve for the excitation of luminescence, the detection of measurement signals and the processing of the measurement signals, the membrane cap comprises the substantially more short-lived sensor membrane. The membrane cap can be replaced with a new membrane cap with a new, similar sensor membrane if the sensor membrane is damaged or can no longer be used due to signs of aging.

Sensor membranes and/or membrane caps are therefore often offered for sale independently, i.e., without an associated sensor body, as accessory for optochemical sensors. In order to ensure optimum functioning of an optochemical sensor with such an exchangeable membrane cap or a replaceable sensor membrane, care should be taken that only sensor membranes suitable for the special application in which the sensor with the new membrane is to be used and/or sensor membranes matched to the respective sensor body are combined with the sensor body to form an optochemical sensor only.

On the other hand, if the sensor body and the sensor membrane are equipped and specified for different applications (and thus not matched to one another), the functionality of the sensor can be impaired, both as regards the measurement of the analyte concentration and also with regard to possible diagnostic functions. This applies even more when the sensor membrane is of lower quality or has been manipulated (product piracy). A mix-up of sensor membranes or the use of sensor membranes, possibly of lower quality, not intended for the sensor body should therefore be excluded as far as possible. An indication provided on a package of the sensor membrane does not appear sufficiently secure against unintended mix-ups or manipulations.

### SUMMARY

The object of the present disclosure is to provide a stable and long-lived sensor membrane for an optochemical sensor and an optochemical sensor featuring such a sensor membrane, said sensor membrane comprising a secure identifier for identifying the sensor membrane, wherein the identifier ideally cannot or can only with very great effort be manipulated or forged.

This object is achieved by a sensor membrane according to claim 1, a membrane cap according to claim 15 and an optochemical sensor according to claim 17. The present disclosure also includes a method for testing and/or identifying a sensor membrane of an optochemical sensor according to claim 18. Advantageous embodiments are listed in the dependent claims.

The sensor membrane according to the present disclosure for an optochemical sensor for determining a measurand correlating with a concentration of an analyte in a measuring fluid comprises:

a functional layer comprising a first polymer matrix doped with a luminescent dye whose emissivity after excitation with electromagnetic radiation can be changed by the analyte;

and

a second polymer matrix in which the functional layer is at least partially encapsulated, and which is permeable to the analyte at least in a subregion facing the measuring fluid and adjacent to the functional layer;

wherein the sensor membrane comprises an optically detectable substance, different from the luminescent dye, for identifying the sensor membrane.

By using an optically detectable substance contained in the sensor membrane to mark the sensor membrane, identification of the sensor membrane is possible by a simple optical test method. It is thus possible to test whether a sensor membrane is suitable for use with a specific sensor body or for use in a specific application. In a specific application, the marking can also provide protection against product piracy.

The functional layer may be formed as a layer having one or more island-shaped functional layer elements.

The second polymer matrix may be formed from the same polymer material as the first polymer matrix. The difference between the first polymer matrix and the second polymer matrix then is that the first polymer matrix is doped with the luminescent dye.

The sensor membrane may comprise a layer stack having a front-side exterior surface intended for contact with the measuring fluid and a back-side exterior surface connected to a substrate.

The second polymer matrix may encapsulate the functional layer in such a way that a first layer of the second polymer matrix covers the functional layer and a second layer of the second polymer matrix is arranged between the functional layer and the substrate, wherein the first and second layers of the second polymer matrix are chemically and/or physically connected to one another in a region surrounding the functional layer. The second polymer matrix at least partially encapsulates the functional layer. In an advantageous embodiment, the second polymer matrix completely encapsulates the functional layer.

In advantageous embodiments, the first and/or second layer of the second polymer matrix may be doped with the optically detectable substance in order to mark the sensor membrane.

In addition to doping with the luminescent dye, the first polymer matrix of the functional layer may be doped with the optically detectable substance in order to mark the sensor membrane.

The optically detectable substance may be selected from the group consisting of: organometallic compounds, such as metal porphyrin complexes, polyaza annulene dyes, for example, polyaza[18]annulene dyes, azaborone dipyrromethenes (Aza-BODIPY), boron dipyrromethenes (BODIPY) and metallophthalocyanine complexes.

The optically detectable substance may differ from the luminescent dye, for example, in that it comprises a different central ion and/or one or more different ligands. If the optically detectable substance is a dye which can be excited to luminescence, the dye is advantageously selected such that its luminescence is not influenced, for example quenched or enhanced, by the same substance, i.e. the same analyte, as the luminescence of the luminescent dye. In order to not impair the function of an optochemical sensor using the sensor membrane, the emission spectra of the luminescent dye used for determining the analyte concentration and the optically detectable substance should differ clearly, i.e., measurably. Such a difference may, for example, be that the optically detectable substance can be excited to luminescence with radiation of a first wavelength, and the luminescent dye can be excited to luminescence with radiation of a second wavelength that differs measurably from the first wavelength, wherein the optically detectable substance cannot be excited to luminescence by radiation of the second wavelength. Another possibility is that radiation emitted by the optically detectable substance after excitation has a different wavelength or a different wavelength range than luminescence radiation emitted by the luminescent dye after excitation.

The optically detectable substance may be a high-conversion material (photon upconversion material), for example, in the form of nanoparticles (UCNPs=upconversion nanoparticles).

The optically detectable substance may comprise one or more inorganic luminescent pigments which consist of an inorganic solid which itself exhibits donor acceptor luminescence or charge transfer luminescence or is doped with one or more luminescent ions, wherein the one or more luminescent ions is or are selected from the group consisting of:

In⁺, Sn²⁺, Pb²⁺, Sb³⁺, Bi³⁺, Ce³⁺, Ce⁴⁺, Pr³⁺, Nd³⁺, Sm²⁺, Sm³⁺, Eu²⁺, Eu³⁺, Gd³⁺, Tb³⁺, Dy³⁺, Ho³⁺, Er³⁺, Tm²⁺, Tm³⁺, Yb²⁺, Yb³⁺, Ti³⁺, V²⁺, V³⁺, V⁴⁺, Mn²⁺, Mn³⁺, Mn⁴⁺, Fe³⁺, Fe⁴⁺, Fe⁵⁺, Co³⁺, Co⁴⁺, Ni⁺, Cu⁺, Ru²⁺, Ru³⁺, Pd²⁺, Ag⁺, Ir³⁺, Pt²⁺ and Au⁺.

The optically detectable substance may comprise an electrochromic material.

The functional layer can be covered with a protective, supporting and/or insulating layer which is permeable to the analyte. Such a layer can be applied directly to the functional layer, for example. Alternatively, it is also possible for the protective, supporting and/or insulating layer to be embedded in the second polymer matrix surrounding the functional layer, for example in the form of a support grid embedded in the polymer matrix. For example, the protective, supporting and/or insulating layer can be at least partially embedded in the second polymer matrix covering the functional layer. The protective, supporting and/or insulating layer may itself consist of a plurality of individual layers.

The protective, supporting and/or insulating layer can be formed from a polymer doped with a pigment, for example, a dark pigment such as soot or activated carbon. This pigment serves to absorb radiation that interferes with the measurement and/or to protect the luminescent dye.

A membrane cap of an optochemical sensor may comprise a sensor membrane according to one of the embodiments described above and a housing, for example, a cylindrical housing, wherein the sensor membrane is arranged on a front side of the housing.

On its side opposite the front side, the housing can be designed to be detachably connected to a sensor body. The sensor body may comprise optical components, for example a radiation source and a detector for luminescence radiation emitted by the luminescent dye of the sensor membrane, and a sensor circuit for controlling the radiation source and for processing signals of the detector. The sensor circuit can further be designed to generate measurement signals for determining a concentration of an analyte on the basis of the detector signals, and optionally process, and output them.

The present disclosure also comprises an optochemical sensor for determining a measurand correlating with a concentration of an analyte in a measuring fluid with a sensor membrane according to one of the embodiments described above,

further comprising:

a probe housing having at least one immersion region designed for immersion into the measuring fluid, the sensor membrane preferably being arranged in the immersion region of the probe housing by means of a membrane cap;

a radiation source arranged in the probe housing for irradiating excitation radiation into the sensor membrane;

a radiation receiver arranged in the probe housing for receiving radiation emitted by the luminescent dye and/or the optically detectable substance; and

a sensor circuit arranged in the probe housing and designed to control the radiation source, receive signals of the radiation receiver, and generate and output signals based on the signals of the radiation receiver.

As described above, the probe housing may be designed to comprise several parts. For example, it may comprise a first part which forms a sensor body and in which the sensor circuit, the radiation source and the radiation receiver are accommodated, and a second part which can be detachably connected to the first part and comprises the sensor membrane. The second part can be realized, for example, in the form of a cap. The two parts of the probe housing can be detachably connected to one another again by means of a plug, clamp or screw connection.

For the measurement, at least one immersion region of the probe housing comprising the sensor membrane is immersed into the measuring fluid, for example a measuring liquid.

The sensor may be configured for measuring different analytes in that it has a memory in which parameters are stored that serve for determining different measurands, e.g., concentrations of different analytes. For example, for the measurement of the concentration of a first analyte (e.g., oxygen), a first parameter set comprising for example a wavelength and/or modulation frequency of the radiation source, calibration parameters or a sensitivity of the radiation receiver, and for the measurement of the concentration of a second analyte (e.g., pH value, CO₂, Na⁺, K⁺), a second parameter set comprising for example a wavelength and/or modulation frequency of the radiation source, calibration parameters or a sensitivity of the radiation receiver may be stored. It is thus possible to convert the sensor by exchanging a first membrane that contains a luminescent dye for the detection of the first analyte, with a second membrane which contains a luminescent dye for the detection of the second analyte, the parameter set matching the sensor membrane being selected in each case for the measurement by means of the sensor circuit. Thus, for example, an oxygen sensor can be converted to a pH sensor by such a membrane replacement. The membrane replacement is advantageously effected by replacing a first membrane cap with a second membrane cap, wherein the membrane caps can each be designed as described above.

In this case, the optically detectable substance contained in the sensor membrane can advantageously serve to identify the type of analyte that can be determined by means of the sensor membrane. This can be done automatically by the sensor itself, as explained further below. On the basis of the detected sensor membrane or the identified type of analyte, the sensor can select the parameters used for the analyte to be determined in each case with the sensor membrane and stored in the memory, and use them for determining the measured value.

The present disclosure also relates to a method for testing and/or identifying a sensor membrane of an optochemical sensor having a functional layer which has a first polymer matrix doped with a luminescent dye whose emissivity after excitation with electromagnetic radiation can be changed by an analyte, and which has a second polymer matrix in which the functional layer is at least partially encapsulated and which is permeable to the analyte at least in a subregion facing the measuring fluid and adjacent to the functional layer, comprising:

testing by means of an optical detection method whether the sensor membrane contains an optically detectable substance that differs from the luminescent dye.

The testing step may comprise the following steps:

exciting the optically detectable substance to emit electromagnetic radiation;

detecting a signal of a radiation receiver configured to receive emission radiation of the optically detectable substance contained in the sensor membrane and convert it into an electrical signal;

and

determining on the basis of the detected signal whether the sensor membrane contains the optically detectable substance.

As mentioned, the optically detectable substance itself can be analyte-sensitive, but it is advantageously not analyte-sensitive, i.e. the radiation emitted by the optically detectable substance upon its excitation is not influenced by the analyte with respect to its wavelength, its intensity or the course of its intensity as a function of time. Ideally, in this case, it is also not influenced by other possible ingredients of the measuring liquid.

The optically detectable substance can be excited by irradiating excitation radiation of one or more specific wavelengths into the sensor membrane. The irradiation of excitation radiation can be carried out by means of a radiation source of the sensor or a radiation source independent of the sensor, for example a radiation source of a test device. Accordingly, the detection of the signal of the radiation receiver may be carried out by means of a radiation receiver of the sensor or by means of a radiation receiver independent of the sensor, e.g., that of a separate test device. The determination of whether the sensor membrane contains the optically detectable substance can be carried out by means of a sensor circuit of the sensor or by means of a circuit of a test device which is independent of the sensor and is connected or can be connected to the radiation receiver. For this purpose, a user or the sensor circuit or the circuit of the test device can automatically compare a characteristic of the radiation received by the radiation receiver with a nominal characteristic stored, for example, in a memory of the sensor or the test device, e.g., one or more reference values. The characteristic may, for example, be a wavelength, an intensity, an intensity profile, a spectrum or a phase angle.

In addition, a further test step can be carried out, comprising:

testing by means of a further method, for example, an optical or chemical method, whether the sensor membrane contains the optically detectable substance.

If the step of testing shows that the sensor membrane contains an optically detectable substance, the method may further comprise identifying the optically detectable substance. The identification can be effected, for example, on the basis of the signal of the radiation receiver detected in the optical detection method or of a value derived therefrom with a catalog of reference values, wherein each reference value represents a specific optically detectable substance. Such reference values may, for example, be intensities, phase angles, or wavelengths of absorption or luminescence maxima. The reference values may be stored in a memory of the sensor or of the test device.

Testing by means of an optical detection method whether the sensor membrane contains an optically detectable substance and, if the testing shows that the sensor membrane contains an optically detectable substance, identifying the optically detectable substance by the optochemical sensor can be carried out by means of a radiation source and a radiation receiver of the optochemical sensor and a sensor circuit and/or a superordinate electronic system connected to the sensor circuit.

As described, the optically detectable substance contained in the sensor membrane forms a captive, non-manipulatable marking of the sensor membrane. This may serve not only to identify the sensor membrane as suitable for a particular application or to counteract product piracy. Additionally or alternatively, traceability of the sensor membrane can also be ensured by means of an optically detectable substance introduced into the sensor membrane. This can be used by the manufacturer of the sensor membranes. For example, a first optically detectable substance may be added to the sensor membranes produced over a certain first time period, for example during a year or a month. After the end of the first time period, a second optically detectable substance that differs from the first can be added to the sensor membranes produced in a subsequent second time period. The first and second optically detectable substances can be selected in such a way that they emit radiation of different wavelengths upon excitation or are excited to emit radiation by excitation radiation of different wavelengths. In this way, sensor membranes produced in the first and second time periods can be distinguished from one another.

Analogously, different optically detectable substances can also be used for different production batches of sensor membranes. In the case of quality defects of individual batches, this makes it possible to locate all specimens of the batches concerned.

Furthermore, the identification of sensor membranes by means of the optically detectable substance can be used to mark sensor membranes that are used for determining a concentration of a specific analyte. For example, a sensor membrane having a first luminescent dye used for detecting a first analyte may be marked with a first optically detectable substance, while a sensor membrane having a second luminescent dye used for detecting a second analyte may be marked with another, second optically detectable substance.

This makes it possible to convert a sensor completely automatically (in the sense of a “plug&play” functionality) from a sensor for determining the concentration of the first analyte to a sensor for determining the concentration of the second analyte by changing the sensor membrane. As described above, such a sensor can be configured to measure different analytes in that it has a memory in which parameters are stored that serve for determining different measurands, e.g., concentrations of different analytes. The sensor can automatically determine which of these parameters the sensor uses in a current measurement by testing in a first step, preferably by means of its radiation source and its radiation receiver, whether the sensor membrane currently used in the sensor contains an optically detectable substance different from the luminescent dye. In the event that the test shows that such an optically detectable substance is present in the sensor membrane, the sensor can identify the optically detectable substance in a second step. For this purpose, for example, the signal of the radiation receiver or a value derived from the signal can be compared during the optical test with reference values representative respectively of various optically detectable substances. Each reference value simultaneously corresponds to a specific analyte which can be determined by means of the sensor membrane. Based on a correspondence of the optical signal with one of the reference values, the optically detectable substance or the respective analyte can be identified as the substance represented by the reference value or as the respective analyte. On the basis of the identification of the substance, the sensor can thus select and apply the parameters to be subsequently used for measurements.

This method can be used particularly advantageously and simply if a change of the sensor membrane is carried out by means of a membrane cap exchange, as described above.

The testing as to whether an optically detectable substance is contained in the sensor membrane and the identification of the optically detectable substance can be carried out by the sensor circuit alone or by a superordinate unit, for example a measurement transmitter or an operating device, wired or wirelessly connected to the sensor circuit for communication.

### BRIEF DESCRIPTION OF THE DRAWINGS

The present disclosure is explained in further detail below on the basis of the exemplary embodiments shown in the figures, as follows:

FIG. 1 shows an optochemical sensor according to a first exemplary embodiment;

FIG. 2 shows an optochemical sensor according to a second exemplary embodiment;

FIG. 3 shows a first exemplary embodiment of a sensor membrane for an optochemical sensor;

FIG. 4 shows a second exemplary embodiment of a sensor membrane for an optochemical sensor;

FIG. 5 shows a third exemplary embodiment of a sensor membrane for an optochemical sensor; and

FIG. 6 shows a fourth exemplary embodiment of a sensor membrane for an optochemical sensor.

### DETAILED DESCRIPTION

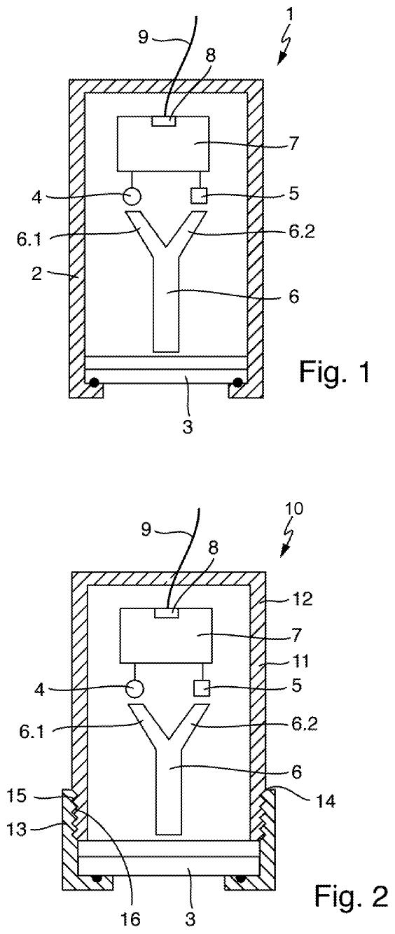

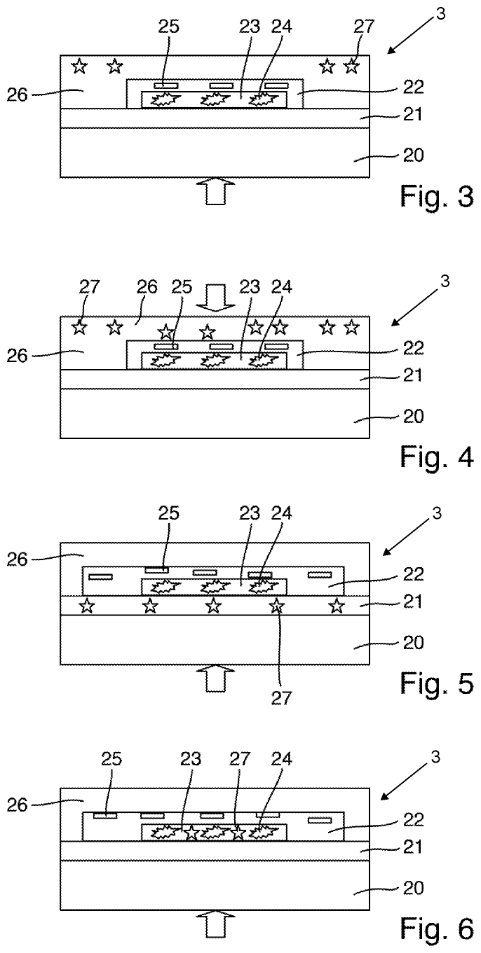

FIG. 1 schematically shows a longitudinal view of an optochemical sensor 1 according to a first exemplary embodiment. In the present exemplary embodiment, sensor 1 is designed to determine a concentration of a gas dissolved in a measuring liquid, for example, dissolved oxygen. The sensor 1 has a probe housing 2 which, in the exemplary embodiment shown here, has a substantially cylindrical design. The probe housing 2 is closed by a sensor membrane 3 at its front end region intended for contact with a measuring medium. The sensor membrane 3 comprises, inter alia, a luminescent dye embedded in a polymer matrix, the luminescence of which is quenched by the analyte, for example oxygen. Alternatively, the luminescent dye may also have the property that its luminescence is enhanced by the analyte. This is the case, for example, in optical pH detection with luminophores on the basis of the photoinduced electron transfer (PET) effect. The sensor membrane 3 may comprise a stabilizing substrate and a plurality of layers applied to the substrate. Their detailed construction is explained in more detail below with reference to FIGS. 3 to 6.

A radiation source 4 which may comprise one or more LEDs, for example, is arranged in the probe housing 2. Furthermore, a radiation receiver 5 which may comprise one or more photodiodes, for example, is also arranged in the probe housing 2. The probe housing 2 also contains a light guide 6 that conducts radiation emitted by the radiation source 4 to the sensor membrane 3 and conducts luminescence radiation emitted by the luminescent dye embedded in the sensor membrane 3 to the radiation receiver 5. The light guide 6 may comprise one or more optical fibers. In the exemplary embodiment shown here, the light guide 6 is formed by a fiber bundle which has a first arm 6.1 that connects the radiation source 4 to the sensor membrane 3 and which has a second arm 6.2 that connects the radiation receiver 5 to the sensor membrane 3. The radiation source 4 and the radiation receiver 5 are electrically connected to a sensor circuit 7. The sensor circuit 7 is designed to excite the radiation source 4 to emit radiation and to control said radiation source. Furthermore, the sensor circuit 7 is designed to receive and process signals of the radiation receiver 5 which represent the luminescence radiation received by the radiation receiver 5. The processed signals serve as measurement signals of the sensor 1 and can be output by the sensor circuit 7 to a superordinate unit, for example a measurement transmitter, a controller, a computer or an operating device, via an interface 8. The interface 8 may be a cable connection fixedly connected to the sensor circuit 7, a detachable plug connection with galvanic contacts or else a galvanically separated, for example, inductively coupling, plug connection. Via the cable 9 connected to the interface 8, the sensor circuit 7 can be supplied with energy, also for operating the radiation source 4. Furthermore, the sensor circuit 7 can transmit signals, for example, data, to the superordinate unit via the cable 9 and, optionally, receive signals, for example, data, from the superordinate unit.

The detection of measured values and the evaluation of the signals of the radiation receiver 5 for determining a measured value can be divided between the sensor circuit 7 and the superordinate unit. For example, the sensor circuit 7 itself can be designed to control the radiation source 4. For this purpose, it can comprise a microcontroller that executes a computer program which is stored in a memory of the sensor circuit 7 and serves to control the radiation source 4 in order to detect measured values. Alternatively, at least part of the functions of the control may also be carried out by the superordinate unit, which then sends corresponding control signals for actuating the radiation source 4 to the sensor circuit 7. Accordingly, in order to process the signals detected by the radiation receiver 5, the microcontroller can execute a computer program which is stored in a memory of the sensor circuit 7 and which serves to evaluate the signals in order to determine measured values. The correspondingly processed signals can be output as measurement signals representing the measured values to the superordinate unit via the interface 8.

In contact with the measuring liquid containing the analyte of a specific concentration, the analyte penetrates into the polymer matrix and interacts with the luminescent dye. If the luminescent dye is excited by radiation of the radiation source 4 to emit luminescence radiation, the luminescence is quenched as a function of the concentration of the analyte, for example in the case of oxygen detection in the polymer matrix. Conversely, an increase in the fluorescence or phosphorescence is however also possible (for example in the case of an optical pH measurement). The sensor circuit 7 detects characteristic parameters by means of the radiation receiver 5 such as, for example, the luminescence intensity, the phase shift of the luminescence signal or also the decay time of the luminescence and determines a measured value of the analyte concentration present in the measuring medium by comparison with a calibration function.

During operation of the sensor 1, the sensor membrane 3 may be subject to aging, especially, if it is subjected during its operating time to sterilization or cleaning processes in which it is subjected to high temperatures and optionally also aggressive cleaning media, for example hot sodium hydroxide solution. This may even result in damage to the sensor membrane 3 which makes any further use of the sensor 1 no longer seem reasonable. In this case, the sensor membrane 3 can be replaced by a new sensor membrane 3. To this end, the sensor 1 must optionally be taken out of operation for a longer period, since the probe housing 2 must be opened in order to replace the sensor membrane 3.

FIG. 2 shows a schematic longitudinal sectional view of a second exemplary embodiment of an optochemical sensor 10. The sensor 10 of the second exemplary embodiment is constructed substantially identically to the sensor 1 of the first exemplary embodiment (FIG. 1), but replacement of the sensor membrane 3 with this sensor 10 is less complex. Identically designed components of the sensors 1, 10 according to the first exemplary embodiment (FIG. 1) and according to the second exemplary embodiment (FIG. 2) are denoted by identical reference signs.

The sensor 10 has a sensor membrane 3 with a luminescent dye, a radiation source 4, a radiation receiver 5 and a light guide 6 designed as a fiber bundle and connects the radiation source 4 and the radiation receiver 5 to the sensor membrane 3 so that excitation light from the radiation source 4 impinges on the sensor membrane 3 and luminescence radiation emitted by the luminescent dye in the sensor membrane 3 reaches the radiation receiver 5. It also comprises a sensor circuit 7 which is electrically connected to the radiation source 4 and the radiation receiver 5 and which can be connected to a superordinate unit via an interface 8. A power supply of the sensor circuit 7 and the transmission of data from the sensor circuit 7 to the superordinate unit takes place via a cable 9. The sensor circuit 7 can be designed analogously to the sensor circuit 7 of the sensor 1 according to the first exemplary embodiment and provides identical functions.

The sensor 10 shown in FIG. 2 differs from the sensor 1 of the first exemplary embodiment substantially in that its probe housing 11 is constructed in two parts. It comprises a first cylindrical housing part which forms a sensor body 12. This sensor body 12 comprises the components of the sensor 10 that have a long service life, such as the sensor circuit 7 and the optical components, i.e. the radiation source 4 and the radiation receiver 5 as well as the light guide 6. At its front end, the sensor body 12 may be open or have a window that is transparent to the excitation radiation and the luminescence radiation.

The probe housing 11 comprises a second housing part which forms a membrane cap 13. Said membrane cap can be detachably connected to the sensor body 12. In the present exemplary embodiment, the connection is realized by a screw connection 14. The membrane cap 13 has a cylindrical housing which has the sensor membrane 3 at its front end. On the rear side, the membrane cap has a thread 15 which cooperates with a complementary thread 16 of the sensor body 12 to form the screw connection 14.

This construction allows a simple replacement of the sensor membrane 3 in that the membrane cap 13 can be replaced by a new, structurally identical membrane cap 13. In this way, the replacement of the sensor membrane 3 does not require any prolonged period of shutdown of the sensor 10.

The structure of the sensor membrane 3 is now described in more detail with reference to FIGS. 3 to 6. FIG. 3 shows a first possible embodiment of the sensor membrane 3 in a schematic longitudinal sectional view. The sensor membrane 3 comprises a substrate 20 and a layer stack of functional and encapsulation layers arranged on the substrate 20. The substrate 20 may consist of a material that is transparent to the excitation radiation and luminescence radiation, for example of glass, ceramic, a polymer, an organometallic compound or zeolite. The substrate material may also be of a hybrid structure and be composed of at least two materials selected from the aforementioned materials. This includes, for example, the use of a hybrid material of two or more polymers or of two or more different ceramics or glasses.

The sensor membrane 3 further comprises a first functional layer 23 composed of one or more island-shaped layer elements (in FIGS. 3 to 6, only one such island-shaped layer element is shown in each case). The first functional layer 23 consists of a first polymer matrix in which a luminescent dye 24 is embedded. The luminescent dye 24 serves as a specific indicator for an analyte to be detected by means of the optochemical sensor 1 or 10. The first polymer matrix may be formed from a polymer or a polymer blend which on the one hand is permeable to the analyte and on the other hand can be doped with the luminescent dye 24. Suitable examples include silicone, porous or non-porous PVDF, PVF, Teflon AF, Hyflon AD, Nafion, a copolymer or terpolymer or n-polymer with a polystyrene unit, e.g., polystyrene co-vinylpyridine, polystyrene co-vinylpyridine co-divinylbenzene, or a blend of several of the polymers mentioned.

The first functional layer 23 is encapsulated in a second polymer matrix. In the present exemplary embodiment, this is achieved by arranging a first layer 21 of the second polymer matrix in a sandwich-like manner between the substrate 20 and the functional layer 23 and by the first functional layer 23 being completely covered by a second layer 22 of the second polymer matrix such that around the island-shaped layer element of the first functional layer 23, the first layer 21 and the second layer 22 of the second polymer matrix lie directly on top of each other and are physically and/or chemically interconnected. The second polymer matrix is designed to be permeable to the analyte at least in a subregion of the second layer 22 covering the first functional layer 23. Preferably, a polymer or a polymer blend is selected as the material of the second polymer matrix, said polymer being chemically stable with respect to the measuring medium and with respect to conventionally used cleaning media, such as sodium hydroxide solution. Ideally, in order to allow the optochemical sensor 1, 10 to be used as universally as possible, the material of the second polymer matrix is also suitable for applications in the field of food technology. Advantageously, the second polymer matrix can consist of the same material as the first polymer matrix, but the second polymer matrix is not doped with the luminescent dye 24. The thus achieved encapsulation of the first functional layer 23 or of the luminescent dye 24 contained therein extends the service life of the sensor membrane 3, since the encapsulation has a protective function for the first functional layer 23. For example, the diffusion or washing of the luminescent dye 24 out of the first functional layer 23 is delayed from the start. Even if the luminescent dye 24 diffuses from the first functional layer 23 into the second polymer matrix, the chemical environment of the luminescent dye substantially does not change so that the sensor membrane 3 does not lose its operability, at least for a time, in the sense that the evaluation of the measurement signals obtained with the sensor membrane 3 results, based on the calibration function, in measured values which still have a sufficient measurement quality. Thus, the sensor membrane 3 shown in FIG. 3 can be used for longer periods of time than conventional sensor membranes, even under rough conditions.

In the present exemplary embodiment, a second functional layer 25, which can be, for example, a protective, supporting or insulating layer, is embedded in the second layer 22 of the second polymer matrix. For example, a layer of an ambient light-absorbing material, e.g., a polymer layer containing soot, may be used as a protective layer. A mechanical support grid, for example made of metal, can be considered as the supporting layer. Of course, it is also possible to provide further functional layers which can be embedded in the second polymer matrix or arranged above or below the second polymer matrix.

In the present exemplary embodiment, the sensor membrane 3 has a final cover layer 26. Said cover layer 26 may be formed from the same polymer material as the second polymer matrix. Alternatively, it may also be formed from another polymer material. The cover layer 26 is optional, i.e. a sensor membrane according to the present disclosure can also be designed in such a way that the second polymer matrix is intended to be brought into direct contact with the measuring medium. The cover layer 26 may consist of a material which is approved for the particular application (for example in the food or pharmaceutical sector). The material of the cover layer 26 may also be optimized with regard to its resistance to chemically aggressive media or other harsh environmental conditions, for example high temperatures or strong mechanical stresses. The cover layer 26 is at least partially permeable to the analyte.

In the embodiment of the sensor membrane 3 shown in FIG. 3, an optically detectable substance 27 is contained in an edge region of the cover layer 26 which is not arranged directly above the functional layer 23.

The optically detectable substance 27 may be a stable organic or inorganic substance or a hybrid material of organic and/or inorganic substances or a mixture of organic and/or inorganic substances. Suitable materials are, for example, organometallic compounds, metal complexes, such as metal porphyrin complexes, polyaza annulene dyes, metallophthalocyanine complexes, azaborone dipyrromethenes (Aza-BODIPY), boron dipyrromethenes (BODIPY) or mixtures of these compounds. The optically detectable substance 27 is different from the luminescent dye 24, for example in that, if they are both metal complexes, it has a different central ion and/or different ligands.

If the optically detectable substance 27 is a luminescent substance, its luminescence is ideally not influenced, e.g., quenched or enhanced, by the analyte determinable by means of the sensor membrane 3 in order to avoid interference of the optically detectable substance 27 serving as marking of the sensor membrane 3 with the detection of measured values by means of the sensor membrane 3. However, this is not absolutely necessary since it is also possible to take into account an interaction of the analyte with the optically detectable substance 27 during the calibration of the sensor 1, 10 and to carry out a corresponding compensation when evaluating the measurement signals. Advantageously, the emission spectra of the optically detectable substance 27 and of the luminescent dye 24 have measurable differences. For example, both substances can be luminescent dyes, wherein the luminescent dye 24 contained in the first functional layer 23 emits, for example, luminescence radiation of a first wavelength, while the optically detectable substance 27 emits luminescence radiation of a second wavelength that differs from the first wavelength. A distance of at least 20 nm, preferably of at least 50 nm, should be present between the first and the second wavelength.

The optically detectable substance 27 may also comprise a high-conversion material (photon upconversion material). These materials convert low-energy to high-energy photons in an anti-Stokes scattering process. They can be, for example, organic materials, such as polycyclic aromatic hydrocarbons, or inorganic materials, such as ions of the d- or f-block elements. It is advantageous for the optically detectable substance 27 to consist of high-conversion nanoparticles (upconverting nanoparticles), e.g., quantum dots or lanthanide-doped nanoparticles, such as fluorides or oxides, e.g., NaYF₄, NaGdF₄, LiYF₄, YF₃, Gd₂O₃, doped with Er³⁺, Yb³⁺, Tm³⁺ or several of these lanthanides.

In further exemplary embodiments, the optically detectable substance 27 can be a stable inorganic material, for example an inorganic luminescence pigment from the series of solid phase substances that exhibits a donor acceptor luminescence or charge transfer luminescence. It may contain, for example, one or more ions from the following group: In⁺, Sn²⁺, Pb²⁺, Sb³⁺, Bi³⁺, Ce³⁺, Ce⁴⁺, Pr³⁺, Nd³⁺, Sm²⁺, Sm³⁺, Eu²⁺, Eu³⁺, Gd³⁺, Tb³⁺, Dy³⁺, Ho³⁺, Er³⁺, Tm²⁺, Tm³⁺, Yb²⁺, Yb³⁺, Ti³⁺, V²⁺, V³⁺, V⁴⁺, Cr³⁺, Mn²⁺, Mn³⁺, Mn⁴⁺, Fe³⁺, Fe⁴⁺, Fe⁵⁺, Co³⁺, Co⁴⁺, N_{Ni}²⁺, Cu⁺, Ru²⁺, Ru³⁺, Pd²⁺, Ag⁺, Ir³⁺, Pt²⁺ and Au⁺. It may further comprise a binary, ternary or quaternary halide, oxide, oxyhalide, sulfide, oxysulfide, sulfate, oxysulfate, selenide, nitride, oxynitride, nitrate, oxynitrate, phosphide, phosphate, carbonate, silicate, oxysilicate, vanadate, molybdate, tungstate, germanate or oxygermanate. These may comprise cations of elements Li, Na, K, Rb, Mg, Ca, Sr, Sc, Y, La, Ti, Zr, Hf, Nb, Ta, Zn, Gd, Lu, Al, Ga and In.

The inorganic material can be present in the sensor membrane 3 as a doping or as nanoparticles embedded in the cover layer 26. The doping or the nanoparticles may form an image or text marking, for example in the form of a lettering, a number or a logo, for example in the form of a hologram.

In an alternative embodiment, the optically detectable substance 27 may also be an electrochromic material. Such materials change color as a result of an electrical pulse; examples of this are indium tin oxide (ITO), Prussian blue or Berlin blue, lithium tungsten oxide and fluorine tin oxide. In this case, the sensor membrane 3 can comprise electrodes or be in contact with electrodes via which a voltage can be applied to the sensor membrane 3 or to a layer of the sensor membrane comprising the optically detectable substance 27, said voltage being dimensioned in such a way that a color change of the optically detectable substance 27 occurs and can be detected optically.

As an optically detectable substance 27 can also be used a substance which changes its color under the influence of a specific influencing variable, e.g., when the pressure or temperature changes or when irradiated with electromagnetic radiation.

In order to ensure universal applicability of the sensor membrane 3, it is advantageous if all materials used are sterilizable up to a temperature of at least 140° C. and/or autoclavable up to at least 121° C. and are stable to customary cleaning and disinfecting agents, such as sodium hydroxide solution or ethylene dioxide. Advantageously, the materials used can also be selected such that they also withstand sterilization with gamma radiation at a dose of at least 5 kGy without degenerating.

The optically detectable substance 27 is also advantageously stable up to a temperature of 140° C. and chemically stable to acids, alkaline solutions and customary disinfectants, such as ethylene oxide. However, this is not strictly necessary if the optically detectable substance is to be used only as a marking of the sensor membrane 3 in order to verify its origin or its suitability for use with a specific sensor body or a specific application during a first installation of the sensor membrane 3. Later destruction of the optically detectable substance 27 when the sensor is used is then not an issue, since detection of the substance 27 is no longer necessary then.

FIG. 4 shows an alternative embodiment of the sensor membrane 3. Identically designed parts of the sensor membranes according to the exemplary embodiment shown in FIG. 3 and according to the exemplary embodiment shown in FIG. 4 are represented with identical reference signs. The sensor membrane 3 has a substrate 20 and a first functional layer 23 of a first polymer matrix with a luminescent dye 24 immobilized therein, the luminescence of which is quenched by the analyte, e.g., in the case of oxygen detection, or is enhanced by the analyte, e.g., in optical pH detection with luminophores based on the photoinduced electron transfer (PET) effect. The first functional layer 23 is encapsulated in a second polymer matrix which is applied to the substrate and the first functional layer 23 in two layers 21, 22 in a manner analogous to the exemplary embodiment as shown in FIG. 3. A second functional layer 25 with soot pigments is embedded in the second layer 22 of the second polymer matrix as a protective layer against ambient light. The sensor membrane 3 is terminated at its end intended for contact with the measuring medium by a cover layer 26 which is doped with an optically detectable substance 27 over its entire cross section. The optically detectable substance 27 can be one of the substances mentioned with reference to the exemplary embodiment of FIG. 3. In contrast to the exemplary embodiment illustrated with reference to FIG. 3, however, in the case of the sensor membrane 3 shown in FIG. 4, care must be taken to select the optically detectable substance 27 in such a way that it does not interfere with the measurement of the luminescence radiation of the luminescent dye 24.

FIG. 5 shows a schematic view of a further exemplary embodiment of the sensor membrane 3. The sensor membrane 3 is designed identically to the sensor membrane 3 shown in FIG. 3 (identical reference signs denote identically designed parts) with the only difference being that the optically detectable substance 27 is not contained in the cover layer 26 but in the first layer 21 of the second polymer matrix encapsulating the first functional layer 23 with the luminescent dye 24. In the present example, this first layer 21 of the second polymer matrix is doped with the optically detectable substance 27. The optically detectable substance 27 can be one of the substances mentioned above.

FIG. 6 schematically shows a last exemplary embodiment of the sensor membrane 3. It is also designed identically to the sensor membrane 3 shown in FIG. 3 (identical reference signs denote identically designed parts) with the only difference being that the optically detectable substance 27 is not contained in the cover layer but together with the luminescent dye 24 in the first functional layer 23. Here, too, the optically detectable substance 27 may be one of the substances mentioned above in connection with the exemplary embodiment according to FIG. 3.

Common to all these embodiments of the sensor membrane 3 is that they contain an optically detectable substance 27 which serves as a marking captively connected to the sensor membrane 3. If the sensor membrane 3 is replaced, this can serve to test whether the new sensor membrane to be used is suitable for use with the sensor 1, 10. Additionally or alternatively, the marking can also serve as protection against forgeries (product piracy) or manipulation.

Furthermore, the marking may also be used for monitoring a production method for sensor membranes or sensors, for example in order to avoid mix-ups of the sensor membranes during production, storage or distribution of the sensor membranes or accessories for the sensor membranes, for example membrane caps. The optically detectable substance can be used especially to allow traceability of sensor membranes which are transferred to users or of accessory parts comprising the sensor membranes. As a result, costs incurred as a result of membranes incorrectly assigned or incorrectly installed in the sensors can be avoided.

If different production batches of sensor membranes are provided with different optically detectable substances, it is possible to distinguish these production batches from one another. For example, when a defect is found in only one production batch, all the sensor membranes concerned can be identified and withdrawn from the market on the basis of the optically detectable substance marking this production batch.

The marking can also serve to automatically identify the analyte, which can be determined by means of the sensor membrane, and to adjust sensor parameters used for analyte determination in an automated manner.

The following procedure can be used to test and/or identify a sensor membrane 3: On the one hand, an optical, non-destructive detection of the optically detectable substance 27 present in the sensor membrane 3 can be carried out by means of an external device. On the other hand, an optical detection of the optically detectable substance 27 present in the sensor membrane 3 can be performed by means of the optochemical sensor in which the membrane is used. The radiation receiver 5 and the sensor circuit 7 and possibly the radiation source 4 can be used for this purpose. It is also possible for the sensor to comprise an additional radiation receiver and/or an additional radiation source which are used specifically for testing or identifying the sensor membrane 3 but not for detecting measured values of the concentration of the analyte to be determined in the measurement operation of the sensor. In FIGS. 3 to 6, arrows are drawn which symbolize the position of the test optics for the detection of the optically detectable substance: In FIGS. 3, 5 and 6, the test optics are arranged on the substrate side; here, the test can therefore, for example, take place by means of the radiation receiver 5 and/or the radiation source 4 of the sensor 1, 10 or alternatively with a separate test device. In FIG. 4, the test optics are arranged on the cover layer side; here, the test is thus carried out by means of an additional test device.

Optionally, there is also the further alternative possibility of testing the sensor membrane 3 by means of a chemical or spectroscopic method, which generally takes place by destroying the sensor membrane 3. However, the test is preferably carried out non-destructively. For particularly difficult or critical cases, destructive measurement may serve as an additional proof, for example, when testing a contiguous batch of a plurality of sensor membranes. In this case, a single one of the plurality of membranes can be examined by destroying it in order to further confirm the results of non-destructive testing of the remaining membranes.

Suitable optical methods for non-destructive measurement with an additional device or with the means of the optochemical sensor itself are, for example, depending on the type of optically detectable substance 27 used, an optical luminescence measurement, an optical absorption measurement or an x-ray measurement. Atomic absorption spectroscopy or flame emission spectroscopy may be used as destructive, especially, wet-chemical or spectroscopic, methods.

All measurement methods known to the person skilled in the art, e.g., detection of an intensity change, of a phase angle, of a decay time, of an absorption or a reflection, may be used for optical luminescence or absorption measurements. Specifically, the following measurements can be used:
a) emission signal or emission spectrum when excited with one or more specific wavelength(s);
b) absorption signal or absorption spectrum measured in reflection;
c) polarization of radiation emitted by or converted by the optically detectable substance, measurable by means of a polarization filter;
d) optical signals (e.g., absorption signal measured in reflection) as a function of the temperature, the pressure, a voltage applied to the sensor membrane;
e) visual detection of discoloration upon change in temperature, pressure, application of a voltage.

Identification or testing can be carried out in a particularly reliable manner by using more than one measurement method. For example, two different non-destructive optical methods, e.g., a luminescence measurement and an absorption measurement in reflection, or two luminescence measurements in which different parameters are detected, e.g., a phase angle and a decay time, can be used for the optical detection of the optically detectable substance.

In a further advantageous variant, the optically detectable substance 27 may be irreversibly variable by ambient conditions which lead to an over-average shortening of the service life of the sensor membrane 3, such as higher temperatures than permitted by specification or other improper treatment of the sensor. In this way, testing of the optically detectable substance allows conclusions to be drawn about the remaining service life of the sensor membrane.

1. A sensor membrane for an optochemical sensor for determining a measurand correlating with a concentration of an analyte in a measuring fluid, the sensor membrane comprising:
a functional layer comprising a first polymer matrix doped with a luminescent dye whose emissivity after excitation with electromagnetic radiation can be changed by the analyte;
a second polymer matrix in which the functional layer is at least partially encapsulated and which is permeable to the analyte at least in a subregion adjacent the measuring fluid and adjacent to the functional layer; and
an optically detectable substance, different from the luminescent dye, for marking the sensor membrane.

2. The sensor membrane of claim 1, wherein the functional layer is a layer having one or more island-shaped functional layer elements.

3. The sensor membrane of claim 1, wherein the second polymer matrix includes a same polymer material as the first polymer matrix.

4. The sensor membrane of claim 1, wherein the sensor membrane comprises a layer stack with a front-side exterior surface intended for contact with the measuring fluid and a back-side exterior surface connected to a substrate.

5. The sensor membrane of claim 1, wherein the second polymer matrix encapsulates the functional layer such that a first layer of the second polymer matrix covers the functional layer and a second layer of the second polymer matrix is disposed between the functional layer and the substrate, and wherein the first layer and the second layer of the second polymer matrix are chemically and/or physically connected to one another in a region surrounding the functional layer.

6. The sensor membrane of claim 5, wherein the first layer and/or the second layer of the second polymer matrix are/is doped with the optically detectable substance to mark the sensor membrane.

7. The sensor membrane claim 1, wherein, in addition to being doped with the luminescent dye, the first polymer matrix of the functional layer is further doped with the optically detectable substance to mark the sensor membrane.

8. The sensor membrane claim 1, wherein the optically detectable substance is selected from the group consisting of organometallic compounds, metal porphyrin complexes, polyaza annulene dyes, polyaza[18]annulene dyes, azaborone dipyrromethenes (Aza-BODIPY), boron dipyrromethenes (BODIPY) and metallophthalocyanine complexes.

9. The sensor membrane claim 1, wherein the optically detectable substance is an upconversion material.

10. The sensor membrane claim 1, wherein the optically detectable substance comprises one or more inorganic luminescent pigments that consist of an inorganic solid, which itself exhibits donor acceptor luminescence or charge transfer luminescence, or is doped with one or more luminescent ions, the one or more luminescent ions being selected from the group consisting of In⁺, Sn²⁺, Pb²⁺, Sb³⁺, Bi³⁺, Ce³⁺, Ce⁴⁺, Pr³⁺, Nd³⁺, Sm²⁺, Sm³⁺, Eu²⁺, Eu³⁺, Gd³⁺, Tb³⁺, Dy³⁺, Ho³⁺, Er³⁺, Tm²⁺, Tm³⁺, Yb²⁺, Yb³⁺, Ti³⁺, V²⁺, V³⁺, V⁴⁺, Mn²⁺, Mn³⁺, Mn⁴⁺, Fe³⁺, Fe⁴⁺, Fe⁵⁺, Co³⁺, Co⁴⁺, Ni²⁺, Cu⁺, Ru²⁺, Ru³⁺, Pd²⁺, Ag⁺, Ir³⁺, Pt²⁺ and Au⁺.

11. The sensor membrane claim 1, wherein the optically detectable substance comprises an electrochromic material.

12. The sensor membrane claim 1, wherein the functional layer is covered with a protective supporting and/or insulating layer that is permeable to the analyte.

13. The sensor membrane claim 12, wherein the protective, supporting and/or insulating layer is at least partially embedded in the second polymer matrix covering the functional layer.

14. The sensor membrane claim 12, wherein the protective, supporting and/or insulating layer is formed from a polymer doped with a pigment.

15. A membrane cap for an optochemical sensor, the membrane cap comprising:
a sensor membrane comprising:
a functional layer comprising a first polymer matrix doped with a luminescent dye whose emissivity after excitation with electromagnetic radiation can be changed by the analyte;
a second polymer matrix in which the functional layer is at least partially encapsulated and which is permeable to the analyte at least in a subregion adjacent the measuring fluid and adjacent to the functional layer; and
an optically detectable substance, different from the luminescent dye, for marking the sensor membrane; and
a housing, wherein the sensor membrane is disposed on a front side of the housing.

16. The membrane cap of claim 15, wherein the housing is configured to be detachably connected to a sensor body on a side of the housing opposite the front side.

17. An optochemical sensor for determining a measurand correlating with a concentration of an analyte in a measuring fluid, the sensor comprising:
a sensor membrane comprising:
a functional layer comprising a first polymer matrix doped with a luminescent dye whose emissivity after excitation with electromagnetic radiation can be changed by the analyte;
a second polymer matrix in which the functional layer is at least partially encapsulated and which is permeable to the analyte at least in a subregion adjacent the measuring fluid and adjacent to the functional layer; and
an optically detectable substance, different from the luminescent dye, for marking the sensor membrane;
a probe housing including at least one immersion region adapted for immersion into the measuring fluid, wherein the sensor membrane is disposed in the immersion region of the probe housing;
a radiation source disposed in the probe housing and configured to irradiate excitation radiation into the sensor membrane;
a radiation receiver disposed in the probe housing and configured to receive radiation emitted by the luminescent dye and/or the optically detectable substance; and
a sensor circuit disposed in the probe housing and configured to control the radiation source, to receive signals from the radiation receiver and to generate and output signals based on the received signals from the radiation receiver.

18. A method for testing and/or identifying a sensor membrane of an optochemical sensor, which includes a functional layer that has a first polymer matrix doped with a luminescent dye whose emissivity after excitation with electromagnetic radiation can be changed by an analyte, and includes a second polymer matrix in which the functional layer is at least partially encapsulated and which is permeable to the analyte at least in a subregion facing the measuring fluid and adjacent to the functional layer, the method comprising:
testing whether the sensor membrane contains an optically detectable substance that differs from the luminescent dye using an optical detection method.

19. The method of claim 18, wherein the testing comprises:
exciting the optically detectable substance to emit electromagnetic radiation;
detecting a signal using a radiation receiver configured to receive emission radiation of the optically detectable substance contained in the sensor membrane and convert the emission radiation into an electrical signal; and
determining whether the sensor membrane contains the optically detectable substance based on the electrical signal.

20. The method of claim 19, further comprising testing whether the sensor membrane contains the optically detectable substance using another optical or chemical method.

21. The method of claim 18, further comprising identifying the optically detectable substance.

22. The method of claim 21, wherein the testing and the identifying is performed using the optochemical sensor including a radiation source, a radiation receiver and a sensor circuit.
